(19) United States
(12) Patent Application Publication
(10) Pub. No.: US 2011/0031335 A1
(43) Pub. Date: Feb. 10, 2011

(54) ELECTROSTATICALLY ATOMIZING DEVICE

(75) Inventor: Kouichi Hirai, Moriyama-shi (JP)

Correspondence Address: Cheng Law Group, PLLC, 1100 17th Street, N.W., Suite 503, Washington, DC, 20036, US

(73) Assignee: PANASONIC ELECTRIC WORKS CO., LTD., Osaka (JP)

(21) Appl. No.: 12/937,537

(22) PCT Filed: Apr. 16, 2009
(86) PCT No.: PCT/JP2009/001766

§ 371 Date: Oct. 12, 2010

(30) Foreign Application Priority Data
Apr. 18, 2008 (JP) 2008-109439

(51) Int. Cl. B05B 5/00

(52) U.S. Cl. 239/690

(57) ABSTRACT

An electrostatically atomizing device in this invention comprises an emitter electrode, cooling means, and a high voltage source. The emitter electrode has a rode and a discharge head which is formed at one axial end of the rod. The cooling means is coupled in a heat transfer relation to one axial end of the rod away from the discharge head in order to cool the emitter electrode for condensation of water thereon from within a surrounding air. The high voltage source is configured to apply a high voltage to the emitter electrode for electrostatically atomizing the water on the discharge head. The emitter electrode includes a flange which is provided at a juncture between the discharge head and the rod to extend radially outwardly of the discharge head and the rod over an entire circumference of the discharge head. The discharge head is tapered to have an outwardly bulged side contour.

### TECHNICAL FIELD

This invention relates to an electrostatically atomizing device being configured to generate a mist of the charged minute water particles, and more particularly to an electrostatically atomizing device having a cooling means being configured to cool an emitter electrode in order to condense vapor in air around the emitter electrode into water which is electrostatically atomized by a high voltage.

### BACKGROUND OF THE INVENTION

Japanese patent application publications No. 2007-54808A and No. 2006-68711A disclose conventional electrostatically atomizing devices. The conventional electrostatically atomizing device is provided for generating a mist of the charged minute water particles of nanometer sizes. The electrostatically atomizing device comprises an emitter electrode, a cooling means, and a high voltage source. The emitter electrode comprises a rod and a discharge head. The rod has one end holding the discharge head and has the other end thermally coupled to the cooling means. The cooling means is configured to cool the discharge head through the rod in order to condense vapor in air around the discharge head into water. Consequently, the water is condensed on the discharge head. The cooling means condenses the vapor in the air into a sufficient amount of the water onto the discharge head immediately after the cooling means is started. A sufficient amount of water supplied onto the discharge head is also a suitable amount of the water for generating the mist of the charged minute water particles by the electrostatically atomization. The high voltage source is configured to apply a high voltage to the emitter electrode in order to electrostatically atomize the water held by the discharge head.

When the cooling means cools the emitter electrode, the water is condensed on a surface of the discharge head. Subsequently, the high voltage source applies the high voltage to the discharge head through the rod, thereby the electrical field being generated between the emitter electrode and ground (earth). The electrical field moves the water on the surface of the discharge head to the tip of the discharge head. Then, the water at the tip of the discharge head is electrically charged by the electrical field. The electrically charged water receives a Coulomb force from electrical field generated between the emitter electrode and ground (earth). As a result, the electrically charged water is pulled along the direction of the electrical field, thereby the Taylor cone being formed at the water on the discharge head. And then, the Taylor cone keeps receiving the Coulomb force, Rayleigh Breakups are caused at the tip of the Taylor cone. According to the Rayleigh Breakups, the mist of the charged minute water particles of nanometer sizes is generated from the tip of the Taylor cone. In this way, the electrostatically atomizing device continuously generates the mist of the charged minute water particles of nanometer sizes without being supplied with the water by users. Therefore, the electrostatically atomizing device with above configurations has high usability.

However, because the cooling means cools the discharge head through the rod, the cooled rod also condenses the vapor in the air surrounding the rod into water on a surface of the rod. The water on the surface of the rod is moved by the electrical field toward the discharge head. Therefore, the discharge head is also supplied with the water from the rod. That is, the discharge head is supplied with excessive amount of the water. In the case where the excessive amount of the water is supplied to the discharge head, the Taylor cone having a shape which is suitable for electrostatically atomizing is not formed.

### DISCLOSURE OF THE INVENTION

This invention is achieved to solve the above problem. The object in this invention is to provide an electrostatically atomizing device being configured to generate the mist of the charged minute water particles stably by forming the Taylor cone having a suitable form for electrostatically atomizing.

An electrostatically atomizing device in accordance with this invention comprises an emitter electrode, a cooling means, and a high voltage source. The emitter electrode has a rod and a discharge head which is formed at one axial end of the rod. The cooling means is coupled in a heat transfer relation to one axial end of the rod away from the discharge head in order to cool the emitter electrode for condensation of water thereon from within a surrounding air. The high voltage source is configured to apply a high voltage to the emitter electrode for electrostatically atomizing the water on the discharge head. A feature of this invention resides in that the emitter electrode further includes a flange which is provided at a juncture between the discharge head and the rod to extend radially outwardly of the discharge head and the rod over an entire circumference of the discharge head. The discharge head is tapered to have an outwardly bulged side contour.

In this case, the flange prevents the water condensed on a surface of the rod from moving to the discharge head. Therefore, a Taylor cone is formed by a suitable amount of water for electrostatically atomizing. In addition, the flange extends radially outwardly of the discharge head. The Taylor cone is formed from a circumference of the bottom of the discharge head toward a tip of the discharge head. That is, the Taylor cone is not formed from a circumference of the flange toward a tip of the discharge head. Therefore, it is possible to prevent the Taylor cone from combining with the water at the circumference of the flange.

It is more preferred that the discharge head has an apex, a bottom, and the bulged side contour. The bulged side contour is located outwardly of pseudo-cone or pseudo-pyramid having the apex and the bottom.

It is further preferred that the emitter electrode further include a needle electrode being disposed at a tip of the discharge head.

In this case, the electrostatically atomizing device is configured to generate a mist of the charged minute water particles with atomizing the water on the tip of the discharge head by applying the high voltage to the water on the discharge head. In addition, it is possible to generate a corona discharge in order to emit a negative ion by applying the high voltage to the tip of the needle electrode in a condition where the discharge head does not hold the water.

It is preferred that the electrostatically atomizing device further comprises a mode selector for selection between a first mode and a second mode. The mode selector in the first mode controls the high voltage source and the cooling means to electrostatically atomize the water on the discharge head. The mode selector in the second mode controls the high voltage source while deactivating the cooling means in order to apply a voltage to the emitter electrode for generating a corona discharge at the needle electrode.

In this case, it is possible to select either the first mode in order to generate the mist of the charged minute water particles or the second mode in order to emit the negative ion.

These and other features and advantages of the present invention will become more apparent from the following best mode for carrying out the present invention and embodiments.

### BRIEF EXPLANATION OF THE DRAWINGS

FIG. 1 shows a side cross sectional view of an electrostatically atomizing device in a first embodiment of this invention.

FIGS. 2A, 2B, and 2C show side views of an emitter electrode employed in the electrostatically atomizing device of the embodiment in this invention.

FIGS. 3A and 3B show side view of a modified emitter electrode in this invention.

FIG. 4 shows a side cross sectional view of the hair dryer that the electrostatically atomizing device in this invention is incorporated.

FIG. 5 shows a side view of the emitter electrode with a needle electrode in this invention.

FIG. 6 shows a side cross sectional view of an electrostatically atomizing device in a second embodiment of this invention

### BEST MODE FOR CARRYING OUT THE INVENTION

Now an electrostatically atomizing device in this invention is explained with using the attached drawings.

### First Embodiment

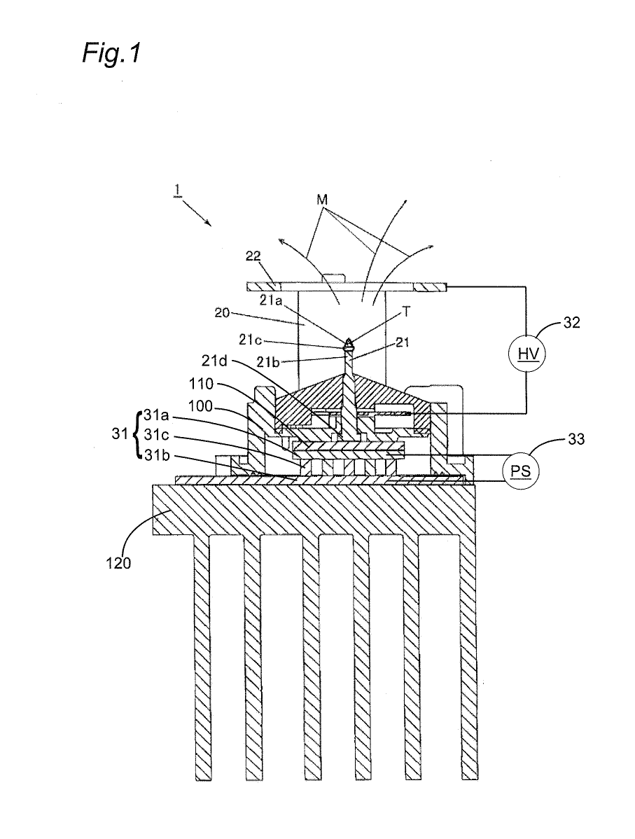

FIG. 1 shows a cross sectional view of the electrostatically atomizing device 1 in this invention. The electrostatically atomizing device 1 in this invention comprises an emitter electrode 21, an opposed electrode 22, a Peltier module 31, a high voltage source 32, a base 100, a holder 20, a cooling plate 110, and a heat radiating fin 120. The base 100 is configured to hold the emitter electrode 21, a Peltier module 31, and a heat radiating fin 120.

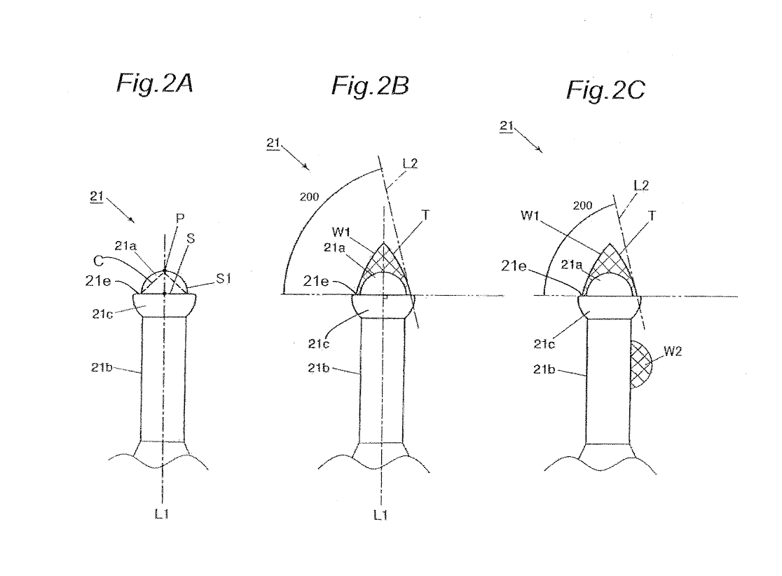

FIG. 2A shows the side view of the emitter electrode 21. As shown in FIG. 1 and FIG. 2A, the emitter electrode 21 has a rod 21b, a pedestal 21d, a discharge head 21a, and a flange 21c. The emitter electrode 21 is made of the electrical conductive material. The rod 21b has one end that an upper surface of the pedestal 21d is fixed, and has the other end holding the discharge head 21a. The pedestal 21d is held by the base 100, thereby the rod 21b being held by the base 100. The emitter electrode 21 has a juncture between the discharge head 21a and the rod 21b.

The flange 21c is provided at the juncture and extends radially outwardly of the discharge head 21a and the rod 21b. The flange 21c is formed to have a diameter perpendicular to an axis L1 of the rod 21b. The diameter of the flange 21c becomes larger from a lower end of the flange 21c toward the tip of the discharge head 21a, thereby the flange 21c having an upper end with a maximum diameter. The discharge head 21a has a maximum diameter perpendicular to the axis L1 of the rod 21b.

The discharge head 21a is formed to have a semi-sphere shape to have a bottom S. Therefore, the discharge head 21a has a pseudo-cone C, an outwardly bulged side contour S1, a tip P, and the bottom S. The tip P of the discharge head 21a is aligned with the axis L1 of the rod 21b. The pseudo-cone C has an apex which is defined by the tip P, and a bottom which is defined by the bottom S. Meanwhile, it is also possible to employ the discharge head 21a which has a pseudo-pyramid, the outward bulged side contour, the tip and the bottom. Consequently, the discharge head 21a is tapered from the bottom S toward the tip P of the discharge head 21a and has an outwardly bulged side contour S1. Diameter of the bottom S is defined as a maximum diameter of the discharge head 21a perpendicular to the axis L1 of the rod 21b.

The maximum diameter of the flange 21c is larger than the maximum diameter of the discharge head 21a. Therefore, an outermost circumference of the discharge head 21a is located inside of an outermost circumference of the flange 21c. Consequently, the outer surface of the discharge head 21a is spaced from the circumference of the top of the flange 21c so as to form an upper surface 21e of the flange 21c. The upper surface 21e is perpendicular to the axis L1 of the rod 21b.

The opposed electrode 22 is provided for electrostatically atomizing the water held on the discharge head 21a smoothly. The opposed electrode 22 is formed to have an annular shape with aperture. The holder 20 has one end holding the opposed electrode 22 and has the other end held by the base 100. Therefore, the opposed electrode 22 is disposed in an opposed relation to the emitter electrode 21.

The high voltage source 32 is configured to apply. a negative high voltage to emitter electrode 21 in order to generate an electrical field between the emitter electrode 21 and the opposed electrode 22.

The Peltier module 31 is defined as a cooling means which is configured to cool the emitter electrode 21 for condensation of water on the emitter electrode 21 from within a surrounding air. The Peltier module 31 includes a pair of electrically conductive circuit plates 31a, 31b and a plurality of thermoelectric conversion elements 31c. The conductive circuit plates 31a, 31b is made of electrical insulation material such as alumina and aluminum nitride. The thermoelectric conversion elements 31c are made of a thermoelectric conversion material such as Bi—Te based. A plurality of the thermoelectric conversion elements 31c are arranged in parallel between the electrical conductive circuit plate 31a and the electrical conductive circuit plate 31b. The electrical conductive circuit plates 31a, 31b receive the voltage by a power source 33. As a result the voltage is applied to the thermoelectric conversion elements 31c. The Peltier module 31 has the conductive circuit plate 31a as a cooling side and the conductive circuit plate 31b as a heat radiating side. The conductive circuit plate 31a is thermally coupled to the pedestal 21d of the electrical conductive circuit plate 31a through the cooling plate 110. Therefore, the Peltier module 31 is thermally coupled to the emitter electrode 21. When the electrical conductive circuit plate 31a is cooled, the emitter electrode 21 is cooled. That is, the Peltier module 31 is coupled in a heat transfer relation to the rod 21b through the pedestal 21d. On the other hand, the electrical conductive circuit plate 31b is coupled to the heat radiating fin 120. Therefore, heat of the electrical conductive circuit plate 31b is transferred toward the heat radiating fin 120 when the electrical conductive circuit plate 31b is heated. The heat of the heat radiating fin 120 is radiated to the air which surrounds the heat radiating fin 120.

This electrostatically atomizing device 1 generates the mist of the charged minute water particles M as follows. When a power button which is not shown in the figure is pressed, the high voltage source 32 and the power source 33 are started. Accordingly, the high voltage source 32 applies the voltage between the emitter electrode 21 and the opposed electrode 22, and the power source 33 applies the voltage to the thermoelectric conversion elements 31c. Then, the thermoelectric conversion elements 31c transfer the heat from the electrically conductive circuit plate 31a to the electrically conductive circuit plate 31b. Consequently, the electrically conductive circuit plate 31a is cooled by the thermoelectric conversion elements 31c. Because the conductive circuit plate 31a is thermally coupled to the cooling plate 110, the electrically conductive circuit plate 31a cools the discharge head 21a of the emitter electrode 21 through the cooling plate 110 and the rod 21b. The discharge head 21a condenses the vapor in the air into water W1 on its surface. In this way, the discharge head 21a is supplied with a suitable and a sufficient amount of the water W1 and holds the water W1 thereon. In addition, the discharge head is formed to have a semi-sphere configuration. Therefore, when the discharge head 21a condenses a vapor into a little amount of the water, a Taylor cone T is immediately formed at the discharge head 21a. That is, the Taylor cone T is formed by a little amount of the water because the discharge head 21a has the outwardly bulged side contour. In addition, because the discharge head 21a is tapered, the Taylor cone T having a suitable form for generating the mist of the charged minute water particles M is formed by a little amount of the water.

Since the high voltage source 32 applies the voltage between the emitter electrode 21 and the opposed electrode 22 as above mentioned, the high voltage source 32 generates the high voltage electrical field between the emitter electrode 21 and the opposed electrode 22. Due to the electrical field, the water on the discharge head 21a is electrically charged. Then, the high voltage electrical field generates Coulomb force. This Coulomb force acts on the electrically charged water on the discharge head 21a such that the Coulomb force pulls the water on the discharge head 21a toward the opposed electrode 22. In this way, the Coulomb force and surface tension of the water forms a Taylor cone T of the water on the discharge head 21a. Subsequently, due to the electrical field, the Taylor cone T of the water on the discharge head 21a is further electrically charged. Then, the high voltage electrical field generates a large Coulomb force. This large Coulomb force pulls the Taylor cone T of the water on the discharge head 21a toward the opposed electrode 22. In this way, the electrical field forms a large Taylor cone T of the water on the discharge head 21a shown in FIG. 2B. This Taylor cone T has a lateral surface which cooperates with the upper surface 21e to form a contact angle 200 which is smaller than 90 degrees.

When the Coulomb force becomes larger than the surface tension, breakups are caused at the tip of the Taylor cone T. The breakup is so-called Rayleigh Breakup. And finally, according to the Rayleigh breakups which are caused at the tip of the Taylor cone T, the mist of the charged minute water particles M of nanometer sizes are generated from the Taylor cone T on the discharge head 21a. The mist of the charged minute water particles M of nanometer sizes is flown through the aperture of the opposed electrode 22.

At this moment, when the discharge head 21a is cooled by the Peltier module 31, the rod 21b is also cooled by the Peltier module 31. Therefore, the rod 21b condenses the vapor within surrounding the air into water on the surface of the rod 21b. According to the condensation of the water by the rod 21b, a droplet W2 is generated on the surface of the rod 21b. The droplet on the surface of the rod 21b is electrically charged by the electrical field between the emitter electrode 21 and the opposed electrode 22. Therefore, the electrical field generates the Coulomb force which pulls the droplet W2 toward the discharge head 21a. However, the flange 21c prevents the droplet W2 at the rod 21b from moving toward the discharge head 21a. Therefore, only the discharge head 21a condenses the vapor into the water thereon, thereby discharge head 21a holding a suitable and a sufficient amount of the water for electrostatically atomizing. That is, the flange 21c makes it possible for discharge head 21a to hold a suitable and a sufficient amount of the water for electrostatically atomizing.

As above mentioned, this electrostatically atomizing device 1 in this embodiment comprises the emitter electrode 21 which has the flange 21c which is provided at the juncture between the discharge head 21a and the rod 21b. This flange 21c prevents the water on the surface of the rod 21b from moving to the discharge head 21a. Therefore, the discharge head 21a is supplied with a suitable and sufficient amount of the water by the Peltier module which cools the discharge head 21a through the rod 21b. On the other hand, the emitter electrode 21 is provided with the flange so as not to supply the water to the discharge head 21a from the rod 21b. Therefore, the discharge head 21a is not supplied with excess water from the rod 21b. Consequently, it is possible to form the Taylor cone T having a suitable form for generating the mist of the charged minute water particles M of nanometer sizes.

In addition, when the discharge head 21a is cooled by the Peltier module 31, the discharge head 21a condenses the vapor within surrounding the air into water. The discharge head 21a holds not much water at the beginning of the condensation of the water. However, the discharge head 21a in this embodiment has the semi-sphere shape. Therefore, it is possible to form the Taylor cone T at the discharge head 21 a with a little amount of the water. Therefore, the mist of the charged minute water particles M is immediately generated after the power source 33 is started.

Furthermore, the discharge head 21a in this embodiment has the semi-sphere shape. That is, the discharge head 21a is tapered to have an outwardly bulged side contour. Therefore, when the discharge head 21a is supplied with the water, the Coulomb force and the surface tension of the water forms the Taylor cone T. The discharge head 21a supports the Taylor cone T to have the suitable form for electrostatically atomizing. Therefore, it is possible to stably generate the mist of the charged minute water particles M from the Taylor cone T.

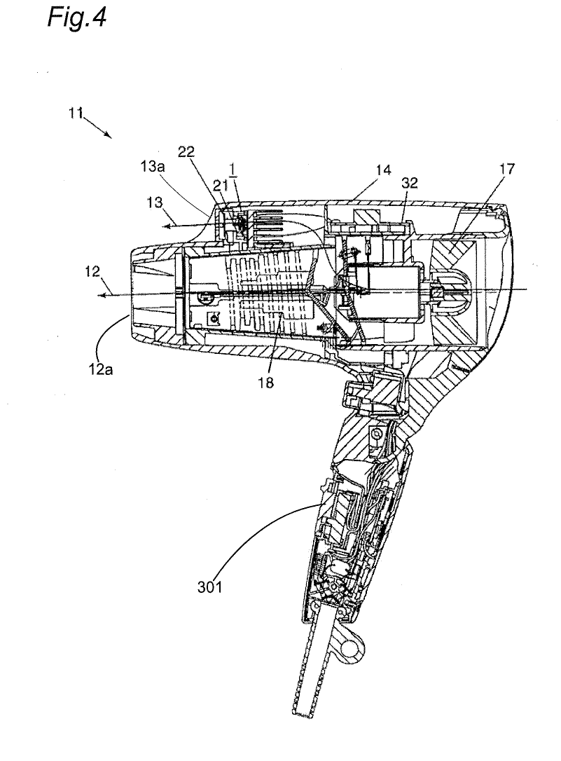

This electrostatically atomizing device 1 is incorporated into a hair care device such as a drier 11. FIG. 4 shows a cross sectional view of the drier 11 with the electrostatically atomizing device 1. This drier comprises a casing 14, a fan 17, a heater 18, and the electrostatically atomizing device 1. The casing is formed to have its inside with an air flow path 12 and a branch air flow path 13. The fan 17 is disposed at an inside of the casing to generate an air flow which flows through the air flow path 12 so as to blow the air from an opening 12a of the casing 14. Furthermore, the fan 17 is disposed at an inside of the casing 14 to generate a branch air flow which flows through the branch air flow path 13 so as to blow the air through a second opening 13a. The heater 18 is disposed between the opening 12a and the fan 17 in order to heat the air which flows through the air flow path 12. The electrostatically atomizing device 1 is disposed in the casing 14 so as to be located at the branch air flow path 13.

When the drier 11 is started, the drier blows a hot air or air at ordinary temperatures from the opening 12a. In addition, when the drier 11 is started, the electrostatically atomizing device 1 generates the mist of the charged minute water particles M. This mist is carried from the drier through the second opening 13a by the branch air flow. Consequently, the drier 11 is configured to blow the hot air or air at ordinary temperature and the mist of the charged minute water particles M to the user.

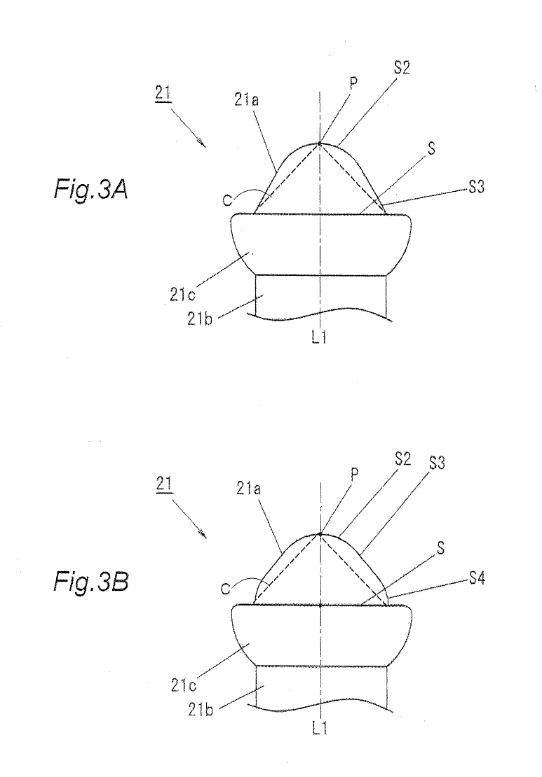

In addition, it is not limited to discharge head 21a having a semi-sphere shape. FIG. 3 shows a first modification of the emitter electrode in this embodiment. The discharge head 21a in FIG. 3A and FIG. 3B are also have a pseudo-cone C, a outwardly bulged side contours S2, S3, S4, a bottom S and a tip P. That is, the discharge head 21a in FIG. 3A and FIG. 3B are also tapered to have a lateral surface which is outwardly bulged. Therefore, the discharge head 21 a in FIG. 3A is tapered to have the outwardly bulged side contours S2 and S3. The discharge head 21a in FIG. 3B is tapered to have outwardly bulged side contours S2, S3 and S4. In each of the modifications, it is possible to stably generate the mist of the charged minute water particles M from the Taylor cone T.

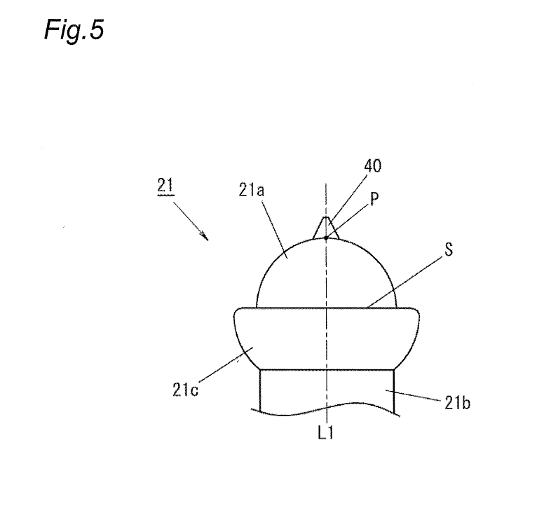

FIG. 5 shows a second modification of the emitter electrode 21 in this embodiment. In this modification, the emitter electrode 21 further comprises a needle electrode 40 having a tip which is aligned with the axis L1 of the rod 21b. As shown in FIG. 5, the needle electrode 40 is formed to have a circular truncated cone. The needle electrode 40 is provided at the tip of the discharge head 21a and extends along the axis L1 of the rod 21b. The needle electrode 40 is integrally formed with the discharge head 21a.

The electrostatically atomizing device 1 with this configuration is configured to generate the corona discharge at the tip of the needle electrode 40 when the high voltage source 32 applies the high voltage between the opposed electrode 22 and the emitter electrode 21 without the water on the discharge head 21a. The corona discharge negatively charges oxygen of the air which surrounds the emitter electrode 21. The negatively charged oxygen is coupled to minute water in the air. As a result, the negative ion is discharged from the electrostatically atomizing device 1. It is preferred that the electrostatically atomizing device 1 in this modification is assembled to the hair care device such as the drier as above mentioned. In the case where the electrostatically atomizing device 1 in this modification is incorporated into the drier 11 shown in FIG. 4, the drier 11 is configured to generate the mist of the charged minute water particles M and is configured to generate the corona discharge. In addition, the needle electrode 40 has a function to form the Taylor cone T having the suitable form for electrostatically atomizing.

### Second Embodiment

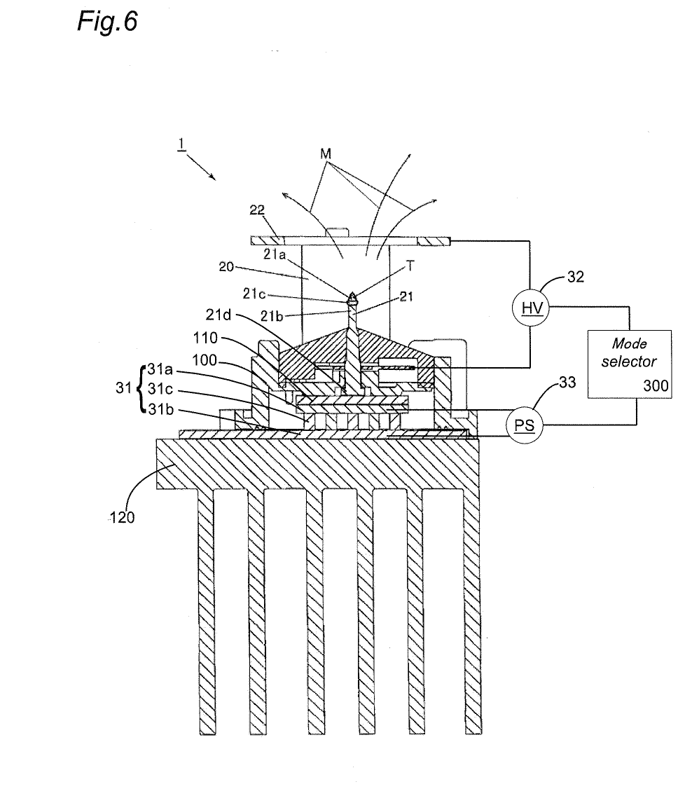

FIG. 6 shows a second embodiment of the electrostatically atomizing device 1 in this invention. The electrostatically atomizing device 1 of this embodiment comprises almost the same elements shown in the first embodiment excepting features shown in this embodiment. Therefore, the elements same as the first embodiment are not explained in this embodiment. In addition, the elements same as the first embodiment are shown by the same numerals.

The electrostatically atomizing device 1 in this embodiment comprises the emitter electrode 21, the opposed electrode 22, the Peltier module 31, the high voltage source 32, the base 100, the holder 20, the cooling plate 110, the heat radiating fin 120, the power source 33, and a mode selector 300.

The emitter electrode 21 in this embodiment is same as the emitter electrode 21 in the second modification of the first embodiment. That is, FIG. 2A also shows the tip of the emitter electrode 21 in this embodiment.

The power source 33 is configured to apply voltage between the electrical conductive plates 31a and 31b in order to apply the voltage between the thermoelectric conversion elements 31c.

The mode selector 300 is provided for selection between a first mode and a second mode such that the electrostatically atomizing device 1 is operated with the first mode or with the second mode. In the first mode, the power source 33 is operated in order to condense the vapor into water on the discharge head 21a, and the high voltage source 32 is operated in order to electrostatically atomizing the water on the discharge head 21a. Consequently, the electrostatically atomizing device 1 generates the mist of the charged minute water particles M. On the other hand, in the second mode, the power source 33 is not operated and the high voltage source 32 is operated in order to apply the voltage between the emitter electrode 21 and the opposed electrode 22. Therefore, the Peltier module is deactivated. Consequently, the electrostatically atomizing device 1 generates the corona discharge at the needle electrode 40.

With this configuration, the electrostatically atomizing device 1 in this embodiment is configured to be operated with the first mode of operating the high voltage source 32 and the Peltier module 31 in order to atomize the water on the discharge head. In addition, the electrostatically atomizing device 1 in this embodiment is configured to be operated with the second mode of operating the high voltage source 32 and deactivating the Peltier module in order to generate the corona discharge at the needle electrode 40. Furthermore, the selector makes it possible for the electrostatically atomizing device 1 to selectively generate the mist of the charged minute water particles M at the discharge head 21a or the corona discharge at the needle electrode 40.

The electrostatically atomizing device 1 in this embodiment is incorporated into the hair care device such as the drier 11 shown in FIG. 4. The drier 11 is provided with a selecting switch 301 for selecting an operation mode of the electrostatically atomizing device 1. The mode selector 300 is configured to select between the first mode and the second mode according to the selection of the selecting switch 301. Consequently, the user is able to use the drier 11 with the first mode or with the second mode. In this way, the drier 11 is configured to generate the mist of the charged minute water particles M or is configured to generate the corona discharge selectively.

1. An electrostatically atomizing device comprising:
an emitter electrode having a rod and a discharge head formed at one axial end of said rod;
cooling means coupled in a heat transfer relation to one axial end of said rod away from said discharge head in order to cool said emitter electrode for condensation of water thereon from within a surrounding air; and
a high voltage source configured to apply a high voltage to said emitter electrode for electrostatically atomizing the water on said discharge head;
wherein
said emitter electrode includes a flange which is provided at a juncture between said discharge head and the rod to extend radially outwardly of said discharge head and said rod over an entire circumference of said discharge head,
said discharge head being tapered to have an outwardly bulged side contour.

2. An electrostatically atomizing device as set forth in claim 1, wherein
said discharge head has an apex, a bottom, and said bulged side contour,
said bulged side contour being located outwardly of pseudo cone or pseudo pyramid having said apex and said bottom

3. An electrostatically atomizing device as set forth in claim 1, wherein
said emitter electrode further includes a needle electrode being disposed at a tip of the discharge head.

4. An electrostatically atomizing device as set forth in claim 1, wherein
said electrostatically atomizing device further comprises a mode selector for selection between a first mode of controlling said high voltage source and said cooling means to electrostatically atomize the water on said discharge head, and a second mode of controlling said high voltage source while deactivating said cooling means in order to apply a voltage to said emitter electrode for generating a corona discharge at said needle electrode.

5. An electrostatically atomizing device as set forth in claim 3, wherein
said electrostatically atomizing device further comprises a mode selector for selection between a first mode of controlling said high voltage source and said cooling means to electrostatically atomize the water on said discharge head, and a second mode of controlling said high voltage source while deactivating said cooling means in order to apply a voltage to said emitter electrode for generating a corona discharge at said needle electrode.
